(19) United States
(12) Patent Application Publication
(10) Pub. No.: US 2026/0359556 A1
(43) Pub. Date: Nov. 12, 2026

(54) INFORMATION PROCESSING APPARATUS, INFORMATION PROCESSING METHOD, AND RECORDING MEDIUM FOR AI-DRIVEN DECISION MAKING SUPPORT

(71) Applicant: NEC Corporation, Tokyo (JP)

(72) Inventor: Hiroaki TAKEUCHI, Tokyo (JP)

(73) Assignee: NEC Corporation, Tokyo (JP)

(21) Appl. No.: 19/553,812

(22) Filed: Mar. 2, 2026

(30) Foreign Application Priority Data
Mar. 13, 2025 (JP) 2025-040585

(51) Int. Cl. G06F 40/177; G06F 40/40

(52) U.S. Cl. CPC G06F 40/177; G06F 40/40

(57) ABSTRACT

An information processing apparatus includes at least one memory configured to store instructions; and at least one processor configured to execute the instructions to: infer meaning of each column of each of multiple tables; setting a column name of each of the columns that are in the different tables and have the same inferred meaning, to a label representing the inferred meaning; acquire an instruction; and generate a first prompt, which is a prompt to be input to a language model that outputs response content for the instruction and includes information related to the instruction, the label, and records associated with the label in the tables.

This application is based upon and claims the benefit of priority from Japanese Patent Application No. 2025-040585, filed on Mar. 13, 2025, the disclosure of which is incorporated herein in its entirety by reference.

### TECHNICAL FIELD

The present disclosure relates to an information processing apparatus, an information processing method, and a recording medium.

### BACKGROUND ART

A technique for generating a response to an instruction from a user with reference to a table stored in a database is known. For example, JP 2024-9724 A discloses a dialogue response candidate proposal system that extracts past question sentences similar to a new question sentence and presents the past question sentences as response candidate sentences. The dialogue response candidate proposal system extracts past question sentences similar to the new question sentence, based on a total similarity obtained by adding a similarity to question information corresponding to each past question sentence stored in a training question-response database and a similarity in a dialogue.

### SUMMARY

In order to generate responses to a wide variety of instructions, a configuration in which a response is generated by referring to multiple tables is preferable. However, in the dialogue response candidate proposal system disclosed in JP 2024-9724 A, a configuration in which a response to a question is generated by referring to multiple tables is not considered.

On the other hand, in a configuration in which a response to an instruction is generated by referring to multiple tables, there is a problem in that, in each of the multiple tables, even in a case where columns have the same meaning, when the column names differ, the accuracy of data retrieval decreases, and the accuracy of the response content also decreases.

The present disclosure has been made in view of the above problem, and one object thereof is to provide a technique for generating highly accurate response content for a wide variety of instructions.

An information processing apparatus according to an exemplary aspect of the present disclosure includes inference means for inferring meaning of each column of each of multiple tables, setting means for setting a column name of each of the columns that are in the different tables and have the same inferred meaning, to a label representing the inferred meaning, acquisition means for acquiring an instruction, and prompt generation means for generating a first prompt, which is a prompt to be input to a language model that outputs response content for the instruction and includes information related to the instruction acquired by the acquisition means, the label, and records associated with the label in the tables.

An information processing method according to another exemplary aspect of the present disclosure includes inference processing of inferring meaning of each column of each of multiple tables, by at least one processor, setting processing of setting a column name of each of the columns that are in the different tables and have the same inferred meaning, to a label representing the inferred meaning, by the at least one processor, acquisition processing of acquiring an instruction, by the at least one processor, and prompt generation processing of generating a first prompt, which is a prompt to be input to a language model that outputs response content for the instruction and includes information related to the instruction acquired in the acquisition processing, the label, and records associated with the label in the tables, by the at least one processor.

A non-transitory recording medium on which an information processing program is recorded, the information processing program causing a computer to function as an information processing apparatus, and causing the computer to function as inference means for inferring meaning of each column of each of multiple tables; setting means for setting a column name of each of the columns that are in the different tables and have the same inferred meaning, to a label representing the inferred meaning; acquisition means for acquiring an instruction; and prompt generation means for generating a first prompt, which is a prompt to be input to a language model that outputs response content for the instruction and includes information related to the instruction acquired by the acquisition means, the label, and records associated with the label in the tables.

### BRIEF DESCRIPTION OF THE DRAWINGS

FIG. 1 is a block diagram illustrating a configuration of an information processing apparatus according to the present disclosure;

FIG. 2 is a flowchart illustrating a flow of an information processing method according to the present disclosure;

FIG. 3 is a block diagram illustrating a configuration of an information processing apparatus according to the present disclosure;

FIG. 4 is a diagram illustrating processing executed by a setting unit according to the present disclosure;

FIG. 5 is a flowchart illustrating a flow of the information processing method according to the present disclosure; and

FIG. 6 is a block diagram illustrating a configuration of a computer functioning as the information processing apparatus according to the present disclosure.

### EXAMPLE EMBODIMENT

Hereinafter, example embodiments of the present disclosure will be described. However, the present disclosure is not limited to the following example embodiments, and various modifications can be made within a scope described in the claims. For example, example embodiments obtained by appropriately combining techniques (some or all of objects or methods) adopted in the following example embodiments can also be included in the scope of the present disclosure. Example embodiments obtained by appropriately omitting some of the techniques adopted in the following example embodiments can also be included in the scope of the present disclosure. Effects mentioned in the following example embodiments are examples of effects expected in the example embodiments, and do not define extension of the present disclosure. That is, example embodiments that do not achieve the effects mentioned in the following example embodiments can also be included in the scope of the present disclosure.

### First Example Embodiment

A first example embodiment that is an example of the example embodiments of the present disclosure will be described in detail with reference to the drawings. The present example embodiment is a basic form of each example embodiment to be described below. An application range of each technique adopted in the present example embodiment is not limited to the present example embodiment. That is, each technique adopted in the present example embodiment can also be adopted in another example embodiment included in the present disclosure within a range in which no particular technical problem occurs. Each technique illustrated in the drawings referred to for describing the present example embodiment can also be adopted in another example embodiment included in the present disclosure within a range in which no particular technical problem occurs.

### Configuration of Information Processing Apparatus 1

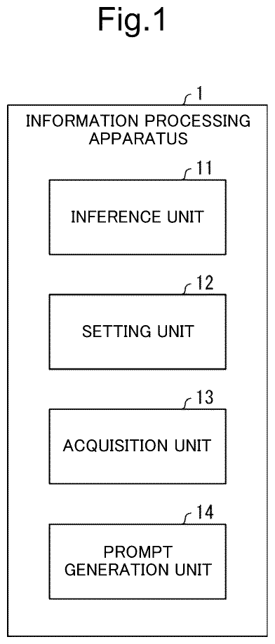

A configuration of an information processing apparatus 1 will be described with reference to FIG. 1. FIG. 1 is a block diagram illustrating the configuration of the information processing apparatus 1. As illustrated in FIG. 1, the information processing apparatus 1 includes an inference unit 11, a setting unit 12, an acquisition unit 13, and a prompt generation unit 14. In the present example embodiment, the inference unit 11, the setting unit 12, the acquisition unit 13, and the prompt generation unit 14 achieve inference means, setting means, acquisition means, and prompt generation means.

### Inference Unit 11

The inference unit 11 infers the meaning of each column of each of the multiple tables. The inference unit 11 supplies an inference result to the setting unit 12.

### Setting Unit 12

The setting unit 12 sets each column name of columns that are in different tables and have the same inferred meaning, to a label representing the inferred meaning. The setting unit 12 supplies the table after the setting to the prompt generation unit 14.

### Acquisition Unit 13

The acquisition unit 13 acquires an instruction. The acquisition unit 13 supplies the acquired instruction to the prompt generation unit 14.

### Prompt Generation Unit 14

The prompt generation unit 14 generates a first prompt, which is a prompt to be input to a language model that outputs response content for the instruction, and which includes information related to the instruction acquired by the acquisition unit 13, the label, and records associated with the label in the tables.

### Effects of Information Processing Apparatus 1

As described above, the information processing apparatus 1 adopts a configuration including the inference unit 11 that infers the meaning of each column of each of the multiple tables, the setting unit 12 that sets each column name of columns that are in different tables and have the same inferred meaning, to a label representing the inferred meaning, the acquisition unit 13 that acquires an instruction, and the prompt generation unit 14 that generates the first prompt, which is a prompt to be input to a language model that outputs response content for the instruction and which includes information related to the instruction acquired by the acquisition unit 13, the label, and records associated with the label in the tables.

That is, with the information processing apparatus 1, a prompt to be input to a language model that outputs response content for the instruction is generated by using the tables in which the column names having the same meaning are set as the labels representing the meaning. Therefore, with the information processing apparatus 1, it is possible to provide a technique for providing a highly accurate response to a wide variety of instructions.

### Flow of Information Processing Method S1

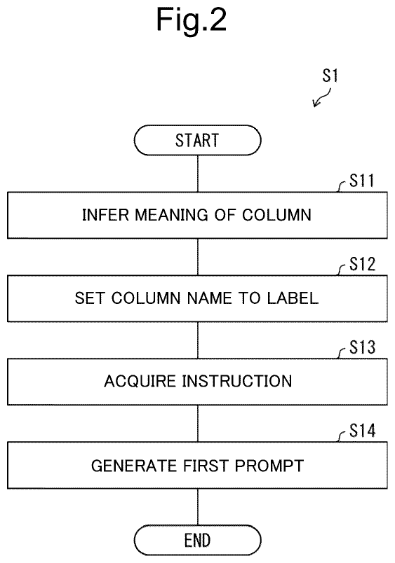

The flow of an information processing method S1 will be described with reference to FIG. 2. FIG. 2 is a flowchart illustrating the flow of the information processing method S1. As illustrated in FIG. 2, the information processing method S1 includes inference processing S11, setting processing S12, acquisition processing S13, and prompt generation processing S14.

### Inference Processing S11

In the inference processing S11, the inference unit 11 infers the meaning of each column of each of the multiple tables. The inference unit 11 supplies an inference result to the setting unit 12.

### Setting Processing S12

In the setting processing S12, the setting unit 12 sets each column name of columns that are in different tables and have the same inferred meaning, to a label representing the inferred meaning.

The setting unit 12 supplies the table after the setting to the prompt generation unit 14.

### Acquisition Processing S13

In the acquisition processing S13, the acquisition unit 13 acquires an instruction. The acquisition unit 13 supplies the acquired instruction to the prompt generation unit 14.

### Prompt Generation Processing S14

In the prompt generation processing S14, the prompt generation unit 14 generates a first prompt, which is a prompt to be input to a language model that outputs response content for the instruction, and which includes information related to the instruction acquired by the acquisition unit 13, the label, and records associated with the label in the tables.

### Effects of Information Processing Method S1

As described above, the information processing method S1 adopts a configuration including the inference processing S11 of inferring, by the inference unit 11, the meaning of each column of each of the multiple tables, the setting processing S12 of setting, by the setting unit 12, each column name of columns that are in different tables and have the same inferred meaning, to a label representing the inferred meaning, the acquisition processing S13 of acquiring an instruction by the acquisition unit 13, and the prompt generation processing S14 of generating, by the prompt generation unit 14, the first prompt, which is a prompt to be input to a language model that outputs response content for the instruction and which includes information related to the instruction acquired by the acquisition unit 13, the label, and records associated with the label in the tables.

Therefore, with the information processing method S1, effects similar to those of the information processing apparatus 1 described above are obtained.

### Second Example Embodiment

A second example embodiment that is an example of the example embodiments of the present disclosure will be described in detail with reference to the drawings. Components having the same functions as the components described in the example embodiment described above are denoted by the same reference signs, and the description thereof will be appropriately omitted. An application range of each technique adopted in the present example embodiment is not limited to the present example embodiment. That is, each technique adopted in the present example embodiment can also be adopted in another example embodiment included in the present disclosure within a range in which no particular technical problem occurs. Furthermore, each technique illustrated in the drawings referred to for describing the present example embodiment may also be adopted in another example embodiment included in the present disclosure within a scope in which no particular technical problem occurs.

### Outline of Information Processing Apparatus 2

The information processing apparatus 2 is an apparatus that generates a prompt (hereinafter also referred to as “first prompt PR1”), which is to be input to a language model LM that refers to records of multiple tables TA and is for generating response content RC for an instruction IN.

More specifically, first, the information processing apparatus 2 sets each column name of columns that are in the multiple tables TA and have the same inferred meaning, to a label representing the inferred meaning. Here, the column of the table TA is information indicating an attribute of each record included in the table, and corresponds to a column of the table.

That is, first, the information processing apparatus 2 sets the column name of the column that is in the multiple tables TA and with which the record having the same attribute is associated, to a label representing the meaning of the column. In the present disclosure, as one example, the information processing apparatus 2 sets a label obtained by translating the inferred meaning into English (a label obtained by translating wording that indicates the inferred meaning into English), as the column name.

The information processing apparatus 2 generates a first prompt, which is a prompt to be input to the language model LM and includes information related to the instruction IN, the label, and data associated with the label in the table TA.

The instruction IN is, as one example, data acquired from the user, and is not limited to an explicit command. For example, in a case where the content of the instruction IN is a question, the information processing apparatus 2 performs processing as an instruction to respond to the question, and in a case where the content of the instruction IN is a request, the information processing apparatus 2 performs processing as an instruction to respond to the request.

In addition, the information related to the instruction IN is not particularly limited as long as the information indicates a relation to the instruction IN. Examples of the information related to the instruction IN include information indicating the instruction IN itself, information indicating key points of the instruction IN, and information indicating a function for responding to the instruction IN.

The label and the data associated with the label in the table TA may be the table TA itself in which the column name has been changed to the label, or may be obtained by converting the label and the data associated with the label in the table TA into character strings.

The information processing apparatus 2 generates response content RC for the instruction IN by inputting the first prompt PR1 to the language model LM.

### Configuration of Information Processing Apparatus 2

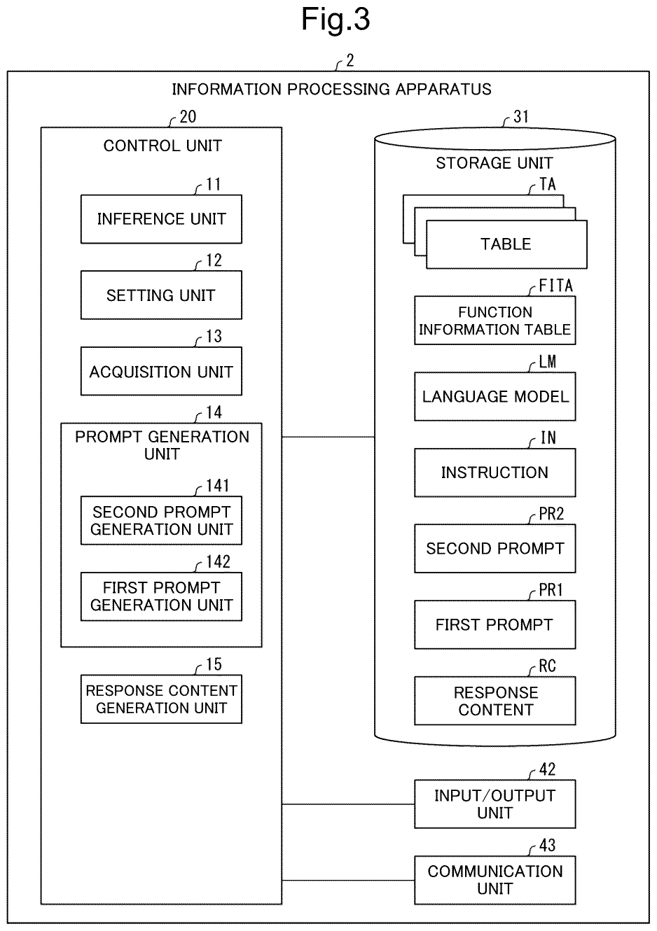

The configuration of the information processing apparatus 2 will be described with reference to FIG. 3. FIG. 3 is a block diagram illustrating a configuration of the information processing apparatus 2. As illustrated in FIG. 3, the information processing apparatus 2 includes a control unit 20, a storage unit 31, an input/output unit 42, and a communication unit 43.

### Storage Unit 31

The storage unit 31 stores data to be referred to by the control unit 20. Examples of the storage unit 31 include, but are not limited to, a flash memory, a Hard Disk Drive (HDD), a Solid State Drive (SSD), and a combination thereof. As illustrated in FIG. 3, examples of the data stored in the storage unit 31 include the multiple tables TA, a function information table FITA, the language model LM, the instruction IN, a second prompt PR2, the first prompt PR1, and the response content RC.

Each of the multiple tables TA is a table in which column names are associated with records. Examples of the multiple tables TA will be described later.

The function information table FITA is a table in which each of multiple functions for causing the language model LM to perform processing on records included in the multiple tables TA is associated with a name of the corresponding function. For example, in a case where each of the multiple tables TA is a table related to transactions, examples of the function information table FITA include the following function names and functions.
• Function name “function 1”: Function “negative slip search function”
• Function name “function 2”: Function “master history search function”
• Function name “function 3”: Function “detailed information search function”

The language model LM is obtained by modeling a language using word occurrence probabilities. Examples of the language model LM include Large Language Models (LLMs) such as Generative Pre-trained Transformer (GPT) and cotomi, and trained models generated by performing transfer learning or fine-tuning using pre-trained models (for example, Chat Generative Pre-trained Transformer (ChatGPT)), but are not limited thereto.

The language model LM performs processing based on an instruction included in a prompt, with the prompt being used as an input. As one example, when the first prompt PR1 is input, the language model LM outputs response content RC for the instruction IN. The fact that the language model LM is stored in the storage unit 31 indicates that parameters defining the language model LM are stored in the storage unit 31.

The instruction IN, the first prompt PR1, and the response content RC are as described above.

The second prompt PR2 is a prompt used to generate the first prompt PR1. More specifically, the second prompt PR2 is a prompt for causing the language model LM to specify a function related to the instruction IN among a plurality of functions that are records included in the function information table FITA. The language model LM that specifies the function related to the instruction IN may be the same language model LM as the language model LM that generates the response content RC for the instruction IN described above, or may be a different language model LM. An example of processing of generating the second prompt PR2 will be described later.

### Input/Output Unit 42

The input/output unit 42 is an interface with an input device that receives an input of data and an output device that outputs data. Examples of the input device include a microphone, a camera, a gaze input device, a keyboard, and a touchpad, but are not limited thereto. Examples of the output device include a speaker and a liquid crystal display, but are not limited thereto. The input/output unit 42 may also be an input device or an output device.

### Communication Unit 43

The communication unit 43 is an interface for transmitting and receiving data via a network. Examples of the communication unit 43 include communication chips in various communication standards such as Ethernet (registered trademark), Wi-Fi (registered trademark), and wireless communication standards for mobile data communication networks, as well as USB-compatible connectors, but are not limited thereto.

### Control Unit 20

The control unit 20 controls each component included in the information processing apparatus 2. As illustrated in FIG. 3, the control unit 20 includes the inference unit 11, the setting unit 12, the acquisition unit 13, the prompt generation unit 14, and a response content generation unit 15. In the present example embodiment, the inference unit 11, the setting unit 12, the acquisition unit 13, the prompt generation unit 14, and the response content generation unit 15 achieve inference means, setting means, acquisition means, prompt generation means, and response content generation means.

### Inference Unit 11

The inference unit 11 infers the meaning of each column of each of the multiple tables TA. The inference unit 11 supplies information indicating the meaning of the inferred column to the setting unit 12. As one example of a method by which the inference unit 11 infers the meaning of each column of each of the multiple tables TA, a data semantic understanding technique can be used.

The data semantic understanding technique is a technique for estimating the meaning of each item of other pieces of data by using a machine learning model trained with training data in which data feature quantities and information indicating the meaning of each item of the data are paired.

As one example, a case will be described in which the data semantic understanding technique is applied to a table TA_E, in which the column names are the English terms “Name”, “Age”, and “Address”, and a plurality of records are associated with each column, and a table TA_G, in which the column names are the Spanish terms “Nombre”, “Anos”, and “Direeccion”, and a plurality of records are associated with each column.

In this case, when the table TA_E and the table TA_G are input to the machine learning model, the machine learning model outputs information indicating that both the English term “Name” and the Spanish term “Nombre” have the meaning of the Japanese term “NAMAE (name)”. Similarly, the machine learning model outputs information indicating that both the English term “Age” and the Spanish term “Anos” have the meaning of the Japanese term “NENREI (age)”, and that both the English term “Address” and the Spanish term “Direeccion” have the meaning of the Japanese term “JUSHO (address)”.

The inference unit 11 estimates the meaning of the column indicating the attribute of the record, from feature quantities of the records included in the tables TA, by using the data semantic understanding technique.

### Setting Unit 12

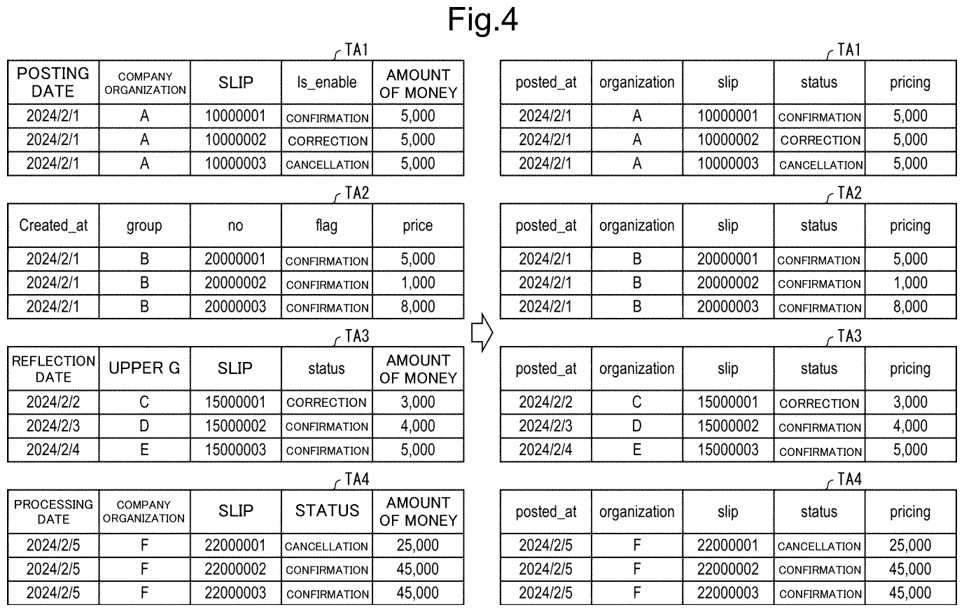

The setting unit 12 sets each column name of columns that are in different tables TA and have the same meaning inferred by the inference unit 11, to a label representing the inferred meaning. The processing executed by the setting unit 12 will be described with reference to FIG. 4. FIG. 4 is a diagram illustrating processing executed by the setting unit 12.

As illustrated on the left side of FIG. 4, the table TA1 to the table TA4 are stored in the storage unit 31, and in each of the table TA1 to the table TA4, column names are associated with records.

For the table TA1 to the table TA4 illustrated on the left side of FIG. 4, in a case where the inference unit 11 infers that the column name “KEIJOBI (posting date)” of the table TA1, the column name “Created_at” of the table TA2, the column name “HANEIBI (reflection date)” of the table TA3, and the column name “SHORIBI (processing date)” of the table TA4 all have the meaning of “MOTOCHO ENO KINYUBI(the date of entry into the ledger) ”, the setting unit 12 first translates “MOTOCHO HENO KINYUBI [symbol] (the date of entry into the ledger)” into English.

Then, as illustrated on the right side of FIG. 4, the column name “KEIJOBI (posting date)” of the table TA1, the column name “Created_at” of the table TA2, the column name “HANEIBI (reflection date)” of the table TA3, and the column name “SHORIBI (processing date)” of the table TA4 are set to a label “posted_at”, which is obtained by translating “MOTOCHO HENO KINYUBI (the date of entry into the ledger)” into English.

For other columns, the setting unit 12 similarly sets the column name of each of the columns having the same meaning inferred by the inference unit 11, to a label obtained by translating the inferred meanings into English. Through this processing, the information processing apparatus 2 can handle, as illustrated on the right side of FIG. 4, the column names that had the same meaning but were not unified among the table TA1 to the table TA4, by using unified column names.

The setting unit 12 may be configured to temporarily set the column names to labels, or may be configured to change the column names to labels. In a case where the column names are changed to labels, after the response content generation unit 15 to be described later generates the response content RC, the setting unit 12 performs processing of restoring the column names to their original names.

### Acquisition Unit 13

The acquisition unit 13 acquires data supplied from the input/output unit 42 or the communication unit 43. The acquisition unit 13 stores the acquired data in the storage unit 31. Examples of the data acquired by the acquisition unit 13 include the table TA, the function information table FITA, and the instruction IN.

### Prompt Generation Unit 14

The prompt generation unit 14 generates a prompt to be input to the language model LM. The prompt generation unit 14 stores the generated prompt in the storage unit 31. As illustrated in FIG. 3, the prompt generation unit 14 includes a second prompt generation unit 141 and a first prompt generation unit 142.

### Second Prompt Generation Unit 141

The second prompt generation unit 141 generates the second prompt PR2 for causing the language model LM to determine a function related to the instruction IN among a plurality of functions for causing the language model LM to perform processing on records included in the multiple tables TA. More specifically, the second prompt generation unit 141 generates the second prompt PR2 for causing the language model LM to determine a function related to the instruction IN among the functions included in the function information table FITA.

As one example, a case will be described in which the acquisition unit 13 acquires an instruction IN indicating a question “the order volume is rapidly decreasing. Why?” and the function information table FITA is as in the example described above. In this case, the second prompt generation unit 141 generates “please select, from among the following functions, a function to be used to generate a response to the question. Functions: ‘negative slip search function’, ‘master history search function’, and ‘detailed information search function’. The user's question is ‘the order volume is rapidly decreasing. Why?’” as the second prompt PR2.

A known method is used as the method by which the second prompt generation unit 141 generates text for the second prompt PR2. In addition, there may be a plurality of function information tables FITA, and the second prompt generation unit 141 may generate the second prompt PR2 by referring to the function information table FITA related to a user.

### First Prompt Generation Unit 142

The first prompt generation unit 142 generates the first prompt PR1, which is a prompt to be input to the language model LM that outputs the response content RC for the instruction IN, and which includes information related to the instruction IN, the label, and records associated with the label in the tables TA.

As one example, the first prompt generation unit 142 first specifies a function related to the instruction IN among the plurality of functions, by inputting the second prompt PR2 to the language model LM. Then, the first prompt generation unit 142 generates the first prompt PR1, which includes an instruction to generate response content RC for the instruction IN using the specified function related to the instruction IN.

For example, a case will be described in which, in a case where the second prompt PR2 is input to the language model LM, the language model LM outputs “the ‘negative slip search function’ can be used to investigate”. In this case, the first prompt generation unit 142 specifies that the function related to the instruction IN is the “negative slip search function”. Then, the first prompt generation unit 142 generates a prompt corresponding to the “negative slip search function”.

For example, in a case where the prompt corresponding to the “negative slip search function” is “this is the table related to slips. Please refer to the table and provide a response explaining why the order volume has become negative”, the first prompt generation unit 142 includes this prompt, as information related to the instruction IN, in the first prompt PR1.

In addition, the first prompt generation unit 142 converts the labels set by the setting unit 12 and the records associated with the labels in the tables TA, into character strings, and includes the character strings in the first prompt PR1. As one example, the first prompt generation unit 142 converts the labels set by the setting unit 12 and the records associated with the labels in the tables TA into a Comma Separated Values (CSV) format, and includes the converted labels and records in the first prompt PR1. The first prompt generation unit 142 may also include, in the first prompt PR1, the table TA1 to the table TA4 themselves illustrated on the right side of FIG. 4.

### Response Content Generation Unit 15

The response content generation unit 15 generates response content RC for the instruction IN by inputting the first prompt PR1 to the language model LM. As one example, the response content generation unit 15 outputs the first prompt PR1 to the language model LM, and generates response content RC including the information output from the language model LM.

With this configuration, the information processing apparatus 2 can provide the user with the response content RC for the instruction IN from the user.

The response content generation unit 15 may also acquire, from the language model LM, a stored procedure that executes a function related to the specified instruction IN. By executing the stored procedure, the response content generation unit 15 can acquire a table related to the response content RC for the instruction IN. With this configuration, the response content generation unit 15 can acquire a table that is more accurate than the table generated by the language model LM. In this case, the response content generation unit 15 may include the acquired table in the response content RC.

### Flow of Processing Executed by Information Processing Apparatus 2

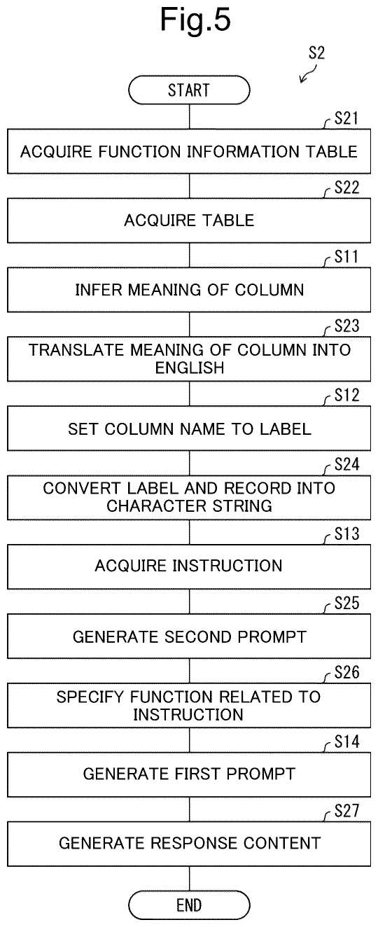

The flow of processing executed by the information processing apparatus 2 will be described with reference to FIG. 5. FIG. 5 is a flowchart illustrating the flow of processing executed by the information processing apparatus 2.

### Step S21

In step S21, the acquisition unit 13 acquires the function information table FITA. The acquisition unit 13 stores the acquired function information table FITA in the storage unit 31.

### Step S22

In step S22, the acquisition unit 13 acquires the tables TA. The acquisition unit 13 stores the acquired tables TA in the storage unit 31.

### Step S11

In step S11, the inference unit 11 infers the meaning of each column of each of the multiple tables TA acquired by the acquisition unit 13 in step S22. The inference unit 11 supplies information indicating the meaning of the inferred column to the setting unit 12.

### Step S23

In step S23, the setting unit 12 translates the meaning of the column inferred by the inference unit 11 in step S11, into English. The setting unit 12 generates a label obtained by translating the inferred meaning of the column into English.

### Step S12

In step S12, the setting unit 12 sets the column name of each of the columns that are in the different tables TA and have the same meaning inferred by the inference unit 11 in step S11, to the label translated in step S23.

### Step S24

In step S24, the first prompt generation unit 142 converts the label set by the setting unit 12 in step S12 and the records associated with the label in the tables TA, into character strings.

The processing of each of step S21 to step S24 may be executed multiple times before the next step S13 is performed.

### Step S13

In step S13, the acquisition unit 13 acquires the instruction IN. The acquisition unit 13 stores the acquired instruction IN in the storage unit 31.

### Step S25

In step S25, the second prompt generation unit 141 generates the second prompt PR2 for causing the language model LM to determine a function related to the instruction IN among a plurality of functions for causing the language model LM to perform processing on records included in the multiple tables TA. The second prompt generation unit 141 stores the generated second prompt PR2 in the storage unit 31.

### Step S26

In step S26, the first prompt generation unit 142 specifies a function related to the instruction IN among the plurality of functions by inputting the second prompt PR2, which is generated by the second prompt generation unit 141 in step S25, to the language model LM.

### Step S14

In step S14, the first prompt generation unit 142 generates the first prompt PR1, which includes an instruction to generate response content RC for the instruction IN using the specified function related to the instruction IN in step S26. The first prompt generation unit 142 stores the generated first prompt PR1 in the storage unit 31.

### Step S27

In step S27, the response content generation unit 15 generates response content RC for the instruction IN by inputting the first prompt PR1, which is generated by the first prompt generation unit 142 in step S14, to the language model LM.

### Effect of Information Processing Apparatus 2

As described above, the information processing apparatus 2 adopts a configuration including the second prompt generation unit 141 that generates the second prompt PR2 for causing the language model LM to determine a function related to the instruction IN among the plurality of functions for causing the language model LM to perform processing on records included in the multiple tables TA, and the first prompt generation unit 142 that specifies a function related to the instruction IN among the plurality of functions by inputting the second prompt PR2 to the language model LM, and generates the first prompt PR1 including an instruction to generate response content RC for the instruction IN using the specified function related to the instruction IN.

Therefore, with the information processing apparatus 2, response content RC for the instruction IN is generated by using a function related to the instruction IN, and thus highly accurate response content RC can be generated.

In addition, in the information processing apparatus 2, the column name in the tables TA is set to the label obtained by translating the inferred meanings into English. Accordingly, with the information processing apparatus 2, for example, as compared with a case where the column name is written in Japanese, it is possible to reduce the number of tokens in the first prompt PR1 to be input to the language model LM.

### Example of Achievement by Software

Some or all of the functions of the information processing apparatuses 1 and 2 (hereinafter also referred to as “the above apparatuses”) may be achieved by hardware such as an integrated circuit (IC chip), or may be achieved by software.

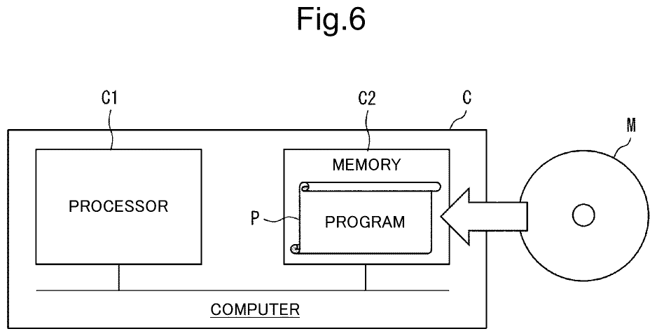

In the latter case, the above apparatuses are achieved by a computer that executes commands of a program that is software for achieving the respective functions. An example of such a computer (hereinafter referred to as a computer C) is illustrated in FIG. 6. FIG. 6 is a block diagram illustrating a hardware configuration of the computer C that functions as the above apparatuses.

The computer C includes at least one processor C1 and at least one memory C2. A program P for causing the computer C to operate as each of the above apparatuses is recorded in the memory C2. In the computer C, the functions of the above apparatuses are achieved by the processor C1 reading and executing the program P from the memory C2.

Examples of the processor C1 include a Central Processing Unit (CPU), a Graphic Processing Unit (GPU), a Digital Signal Processor (DSP), a Micro Processing Unit (MPU), a Floating Point Number Processing Unit (FPU), a Physics Processing Unit (PPU), a Tensor Processing Unit (TPU), a quantum processor, and a microcontroller, as well as combinations thereof. Examples of the memory C2 include a flash memory, a Hard Disk Drive (HDD), a Solid State Drive (SSD), and combinations thereof.

The computer C may further include a Random Access Memory (RAM) for loading the program P at the time of execution and temporarily storing various kinds of data. The computer C may further include a communication interface for transmitting and receiving data with another apparatus. The computer C may also further include an input/output interface for connecting input/output devices such as a keyboard, a mouse, a display, and a printer.

The program P may be recorded on a non-transitory tangible recording medium M readable by the computer C. Examples of such a recording medium M include a tape, a disk, a card, a semiconductor memory, or a programmable logic circuit.

The computer C can acquire the program P via such a recording medium M. The program P can also be transmitted via a transmission medium. Examples of such a transmission medium include a communication network or broadcast waves. The computer C can also acquire the program P via such a transmission medium.

Each of the above functions of the above apparatuses may be achieved by a single processor provided in a single computer, may be achieved in cooperation with a plurality of processors provided in a single computer, or may be achieved in cooperation with a plurality of processors provided in a plurality of computers. The program for causing the above apparatuses to achieve the above functions may be stored in a single memory provided in a single computer, may be stored in a distributed manner in a plurality of memories provided in a single computer, or may be stored in a distributed manner in a plurality of memories provided in a plurality of computers.

### Supplementary Note Matter A

The present disclosure includes the techniques described in the following supplementary notes. However, the present disclosure is not limited to the techniques described in the following supplementary notes, and various modifications can be made within the scope described in the claims.

### Supplementary Note A1

An information processing apparatus including:
inference means for inferring meaning of each column of each of multiple tables;
setting means for setting a column name of each of the columns that are in the different tables and have the same inferred meaning, to a label representing the inferred meaning;
acquisition means for acquiring an instruction; and
prompt generation means for generating a first prompt, which is a prompt to be input to a language model that outputs response content for the instruction and includes information related to the instruction acquired by the acquisition means, the label, and records associated with the label in the tables.

### Supplementary Note A2

The information processing apparatus according to Supplementary Note A1, in which
the prompt generation means further
generates a second prompt for causing the language model to determine a function related to the instruction among a plurality of functions for causing the language model to execute processing on the records included in the multiple tables,
specifies the function related to the instruction among the plurality of functions by inputting the second prompt to the language model, and
generates the first prompt including an instruction to generate response content for the instruction by using the specified function related to the instruction.

### Supplementary Note A3

The information processing apparatus according to Supplementary Note A1 or A2, further including: response content generation means for generating response content for the instruction acquired by the acquisition means by inputting the first prompt to the language model.

### Supplementary Note A4

The information processing apparatus according to any one of Supplementary Notes A1 to A3, in which the setting means sets the column name to a label obtained by translating the inferred meaning into English.

### Supplementary Note A5

An information processing apparatus including:
inference means for inferring meaning of each column of each of multiple tables; and
setting means for setting a column name of each of the columns that are in the different tables and have the same inferred meaning, to a label representing the inferred meaning.

### Supplementary Note Matter B

The present disclosure includes the techniques described in the following supplementary notes. However, the present disclosure is not limited to the techniques described in the following supplementary notes, and various modifications can be made within the scope described in the claims.

### Supplementary Note B1

An information processing method including:
inference processing of inferring meaning of each column of each of multiple tables, by at least one processor;
setting processing of setting a column name of each of the columns that are in the different tables and have the same inferred meaning, to a label representing the inferred meaning, by the at least one processor;
acquisition processing of acquiring an instruction, by the at least one processor; and
prompt generation processing of generating a first prompt, which is a prompt to be input to a language model that outputs response content for the instruction and includes information related to the instruction acquired in the acquisition processing, the label, and records associated with the label in the tables, by the at least one processor.

### Supplementary Note B2

The information processing method according to Supplementary Note B1, in which
in the prompt generation processing, the at least one processor further
generates a second prompt for causing the language model to determine a function related to the instruction among a plurality of functions for causing the language model to execute processing on the records included in the multiple tables,
specifies the function related to the instruction among the plurality of functions by inputting the second prompt to the language model, and
generates the first prompt including an instruction to generate response content for the instruction by using the specified function related to the instruction.

### Supplementary Note B3

The information processing method according to Supplementary Note B1 or B2, further including: response content generation processing of generating response content for the instruction acquired in the acquisition processing by inputting the first prompt to the language model, by the at least one processor.

### Supplementary Note B4

The information processing method according to any one of Supplementary Notes B1 to B3, in which in the setting processing, the at least one processor sets the column name to a label obtained by translating the inferred meaning into English.

### Supplementary Note B5

An information processing method including:
inference processing of inferring meaning of each column of each of multiple tables, by at least one processor; and
setting processing of setting a column name of each of the columns that are in the different tables and have the same inferred meaning, to a label representing the inferred meaning, by the at least one processor.

### Supplementary Note Matter C

The present disclosure includes the techniques described in the following supplementary notes. However, the present disclosure is not limited to the techniques described in the following supplementary notes, and various modifications can be made within the scope described in the claims.

### Supplementary Note C1

An information processing program causing a computer to function as an information processing apparatus, and causing the computer to function as:
inference means for inferring meaning of each column of each of multiple tables;
setting means for setting a column name of each of the columns that are in the different tables and have the same inferred meaning, to a label representing the inferred meaning;
acquisition means for acquiring an instruction; and
prompt generation means for generating a first prompt, which is a prompt to be input to a language model that outputs response content for the instruction and includes information related to the instruction acquired by the acquisition means, the label, and records associated with the label in the tables.

### Supplementary Note C2

The information processing program according to Supplementary Note C1, in which
the prompt generation means further
generates a second prompt for causing the language model to determine a function related to the instruction among a plurality of functions for causing the language model to execute processing on the records included in the multiple tables,
specifies the function related to the instruction among the plurality of functions by inputting the second prompt to the language model, and
generates the first prompt including an instruction to generate response content for the instruction by using the specified function related to the instruction.

### Supplementary Note C3

The information processing program according to Supplementary Note C1 or C2, causing the computer to further function as:
response content generation means for generating response content for the instruction acquired by the acquisition means by inputting the first prompt to the language model.

### Supplementary Note C4

The information processing program according to any one of Supplementary Notes C1 to C3, in which the setting means sets the column name to a label obtained by translating the inferred meaning into English.

### Supplementary Note C5

An information processing program causing a computer to function as an information processing apparatus, and causing the computer to function as:
inference means for inferring meaning of each column of each of multiple tables; and
setting means for setting a column name of each of the columns that are in the different tables and have the same inferred meaning, to a label representing the inferred meaning.

### Supplementary Note Matter D

The present disclosure includes the techniques described in the following supplementary notes. However, the present disclosure is not limited to the techniques described in the following supplementary notes, and various modifications can be made within the scope described in the claims.

### Supplementary Note D1

An information processing apparatus including:
at least one processor, in which the at least one processor executes
inference processing of inferring meaning of each column of each of multiple tables;
setting processing of setting a column name of each of the columns that are in the different tables and have the same inferred meaning, to a label representing the inferred meaning;
acquisition processing of acquiring an instruction; and
prompt generation processing of generating a first prompt, which is a prompt to be input to a language model that outputs response content for the instruction and includes information related to the instruction acquired in the acquisition processing, the label, and records associated with the label in the tables.

The information processing apparatus may further include a memory. The memory may store a program for causing the at least one processor to execute each of the processing.

### Supplementary Note D2

The information processing apparatus according to Supplementary Note D1, in which
in the prompt generation processing, the at least one processor further
generates a second prompt for causing the language model to determine a function related to the instruction among a plurality of functions for causing the language model to execute processing on the records included in the multiple tables,
specifies the function related to the instruction among the plurality of functions by inputting the second prompt to the language model, and
generates the first prompt including an instruction to generate response content for the instruction by using the specified function related to the instruction.

### Supplementary Note D3

The information processing apparatus according to Supplementary Note D1 or D2, in which
the at least one processor further executes response content generation processing of generating response content for the instruction acquired in the acquisition processing by inputting the first prompt to the language model.

### Supplementary Note D4

The information processing apparatus according to any one of Supplementary Notes D1 to D3, in which in the setting processing, the at least one processor sets the column name to a label obtained by translating the inferred meaning into English.

### Supplementary Note D5

An information processing apparatus including:
at least one processor, in which the at least one processor executes
inference processing of inferring meaning of each column of each of multiple tables; and
setting processing of setting a column name of each of the columns that are in the different tables and have the same inferred meaning, to a label representing the inferred meaning.

### Supplementary Note Matter E

The present disclosure includes the techniques described in the following supplementary notes. However, the present disclosure is not limited to the techniques described in the following supplementary notes, and various modifications can be made within the scope described in the claims.

### Supplementary Note E1

A non-transitory recording medium on which an information processing program is recorded, the information processing program causing a computer to function as an information processing apparatus, and causing the computer to execute:
inference processing of inferring meaning of each column of each of multiple tables;
setting processing of setting a column name of each of the columns that are in the different tables and have the same inferred meaning, to a label representing the inferred meaning;
acquisition processing of acquiring an instruction; and
prompt generation processing of generating a first prompt, which is a prompt to be input to a language model that outputs response content for the instruction and includes information related to the instruction acquired in the acquisition processing, the label, and records associated with the label in the tables.

According to one exemplary aspect of the present disclosure, it is possible to obtain an exemplary effect of providing a technique for generating highly accurate response content for a wide variety of instructions.

1. An information processing apparatus comprising:
at least one memory configured to store instructions; and
at least one processor configured to execute the instructions to:
infer meaning of each column of each of multiple tables;
set a column name of each of the columns that are in the different tables and have the same inferred meaning, to a label representing the inferred meaning;
acquire an instruction; and
generate a first prompt, which is a prompt to be input to a language model that outputs response content for the instruction and includes information related to the instruction, the label, and records associated with the label in the tables.

2. The information processing apparatus according to claim 1, wherein the at least one processor is further configured to execute the instructions to:
generate a second prompt for causing the language model to determine a function related to the instruction among a plurality of functions for causing the language model to execute processing on the records included in the multiple tables,
specify the function related to the instruction among the plurality of functions by inputting the second prompt to the language model, and
generate the first prompt including an instruction to generate response content for the instruction by using the specified function related to the instruction.

3. The information processing apparatus according to claim 1, wherein the at least one processor is further configured to execute the instructions to:
generate response content for the instruction acquired by the acquisition means by inputting the first prompt to the language model.

4. The information processing apparatus according to claim 1, wherein the at least one processor is further configured to execute the instructions to:
set the column name to a label obtained by translating the inferred meaning into English.

5. An information processing method comprising:
inference processing of inferring meaning of each column of each of multiple tables, by at least one processor;
setting a column name of each of the columns that are in the different tables and have the same inferred meaning, to a label representing the inferred meaning, by the at least one processor;
acquiring an instruction, by the at least one processor; and
generating a first prompt, which is a prompt to be input to a language model that outputs response content for the instruction and includes information related to the instruction, the label, and records associated with the label in the tables, by the at least one processor.

6. A non-transitory recording medium on which an information processing program is recorded, the information processing program causing a computer to execute:
inferring meaning of each column of each of multiple tables;
setting a column name of each of the columns that are in the different tables and have the same inferred meaning, to a label representing the inferred meaning;
acquiring an instruction; and
generating a first prompt, which is a prompt to be input to a language model that outputs response content for the instruction and includes information related to the instruction, the label, and records associated with the label in the tables.
